(19) United States
(12) Patent Application Publication
(10) Pub. No.: US 2025/0175834 A1
(43) Pub. Date: May 29, 2025

(54) PER DATA RADIO BEARER (DRB) DELAY THRESHOLD CONFIGURATION

(71) Applicant: Telefonaktiebolaget LM Ericsson (publ), Stockholm (SE)

(72) Inventors: Sakib BIN REDHWAN, Linköping (SE); Pradeepa RAMACHANDRA, Linköping (SE); Ali PARICHEHREHTEROUJENI, Linköping (SE); Angelo CENTONZA, Granada (ES)

(21) Appl. No.: 18/835,679

(22) PCT Filed: Feb. 9, 2023
(86) PCT No.: PCT/SE2023/050109

§ 371 Date: Aug. 2, 2024

Related U.S. Application Data
(60) Provisional application No. 63/308,738, filed on Feb. 10, 2022.

(51) Int. Cl. H04W 24/10

(52) U.S. Cl. CPC H04W 24/10

(57) ABSTRACT

A method performed by a wireless device to receive an excess delay measurement configuration from a serving radio access network, RAN, node and perform measurements according to the excess delay configuration includes receiving an excess delay configuration to perform uplink PDCP excess delay measurements, the excess delay configuration including a list of PDCP excess delay thresholds associated with data radio bearer, DRB, identities, IDs. The method includes performing uplink PDCP excess delay measurements based on threshold values in the excess delay configuration. The method includes transmitting an excess delay measurement report to the serving RAN node, the excess delay measurement report including a list of PDCP excess delay measurements.

### TECHNICAL FIELD

The present disclosure relates generally to communications, and more particularly to communication methods and related devices and nodes supporting wireless communications.

### BACKGROUND

### NR Architecture

The current 5G radio access network, RAN, (NG-RAN) architecture is depicted and described in the 3rd generation partnership (3GPP) technical standard (TS) 38.401 version 16.5.0, wherein the overall architecture of NG-RAN is illustrated in FIG. 1.

The NG architecture can be further described as follows:
The NG-RAN consists of a set of gNBs connected to the 5G core (5GC) through the NG-RAN.
An gNB can support frequency division duplexing (FDD) mode, time division duplexing (TDD) mode or dual mode operation.
gNBs can be interconnected through the Xn interface.
A gNB may consist of a gNB centralized unit (gNB-CU) and gNB-distributed units (gNB-DUs). A gNB-CU and a gNB-DU are inter-connected via the F1 logical interface.
One gNB-DU is connected to only one gNB-CU.
   NOTE: For resiliency, a gNB-DU may be connected to multiple gNB-CU by appropriate implementation.

NG, Xn and F1 are logical interfaces. The NG-RAN is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and control plane (signaling) transport. If security protection for control plane and user plane data on the TNL of NG-RAN interfaces has to be supported, network domain security (NDS)/Internet Protocol (IP) (3GPP TS 33.401) shall be applied.

A gNB may also be connected to a long term evolution (LTE) evolved-universal terrestrial radio access network node B (eNB) via the X2 interface. Another architectural option is that where an LTE eNB connected to the Evolved Packet Core (EPC) network is connected over the X2 interface with a so called en-gNB. The latter is a gNB not connected directly to a core network (CN) and connected via X2 to an eNB for the sole purpose of performing dual connectivity.

The architecture in FIG. 1 can be expanded by spitting the gNB-CU into two entities as illustrated in one embodiment in FIG. 2. In the split architecture option, the RAN protocol stack functionality is separated in different parts. The gNB-CU-control plane (CP) (gNB-CU-CP or CU-CP) is expected to handle the radio resource control (RRC) layer, the gNB-CU-user plane (UP) (gNB-CU-UP or CU-UP) will handle the protocol data convergence protocol (PDCP) layer and the gNB-DU will handle the radio link control (RLC), medium access control (MAC) and physical (PHY) layer of the protocol stack. In some further split the gNB-DU can have separated unit that handles the PHY parts separately compared to RLC and MAC layers that are handled in a gNB-DU.

As different units handle different protocol stack functionalities, there will be a need for inter-node communication between the gNB-DU, the gNB-CU-UP and the gNB-CU-CP. This is achieved via the F1-C interface related to control plane signaling, via the F1-U interface related to user plane signaling for communication between gNB-CU and gNB-DU and via the E1 interface for communication between gNB-CU-UP and gNB-CU-CP.

The E1 interface is a logical interface. It supports the exchange of signaling information between the endpoints. From a logical standpoint, the E1 interface is a point-to-point interface between a gNB-CU-CP and a gNB-CU-UP. The E1 interface enables exchange of UE associated information and non-UE associated information. The E1 interface is a control interface and is not used for user data forwarding.

### Packet Delay Measurement

In LTE, as part of total RAN delay measurements, UE performs packet delay measurement in the uplink direction. It is defined in TS 36.314 [2] as UL PDCP Packet Delay per quality of service class identifier (QCI).

### SUMMARY

There currently exist certain challenge(s). Similar to LTE, Excess delay measurement has been proposed to be introduced in NR. However, one significant difference between NR and LTE is that for NR, the configuration would be per data radio bearer (DRB), instead of per QCI. Proposals for introducing new information elements (IEs) has been made in 3GPP. On the other hand, it was proposed that the new IE would follow LTE principle of configuration. However, details of the new IE have not been proposed.

In LTE, a threshold configuration is sent to a wireless device based on which it can calculate an excess delay ratio. This is sent through the UL-DelayConfig IE. In next radio (NR), the PDCP delay calculation can be configured for certain DRBs and the DRBs can be mapped to a wide range of physical layer resources. It is not feasible to set one threshold value that can effectively represent excess delay for DRBs that are mapped to high frequency physical channels and DRBs that are mapped to low frequency physical channels. With the existing approach, an ultra reliable low latency communications (URLLC) related DRB and a mobile broadband (MBB) related DRB need to be configured with the same delay threshold configuration which is not ideal from an operator's flexibility point of view when it comes to QoS related measurement collection from the UE.

Additionally, it is difficult with such configuration to trigger network specific actions in the case when the excess delay ratio exceeds certain limits. As an example, certain services may be able to tolerate higher excess delays and for that they should not be subject to specific network actions when the excess delay ratio increases, while other services may drastically suffer from increased excess delay ratio increases and for that the network may need to take actions to reduce such delays.

Certain aspects of the disclosure and their embodiments may provide solutions to these or other challenges. According to some embodiments, a method performed by a wireless device to receive an excess delay measurement configuration from a serving radio access network, RAN, node and perform packet data convergence protocol, PDCP, excess delay measurements according to the excess delay configuration is provided. The method includes receiving an excess delay configuration to perform uplink PDCP excess delay measurements, the excess delay configuration including a list of PDCP excess delay thresholds associated with data radio bearer, DRB, identities, IDs. The method further includes performing uplink PDCP excess delay measurements based on threshold values in the excess delay configuration. The method includes transmitting an excess delay measurement report to the serving RAN node, the excess delay measurement report including a list of PDCP excess delay measurements.

Certain embodiments may provide one or more of the following technical advantage(s). Various embodiments allow the network to set thresholds to calculate excess delay in a flexible manner and thus the result reported by the UE reflects delay measurements that is reflective of a use case, like URLLC or MBB. In addition, the solution enables the RAN node to configure the excess delay measurements per DRB characteristics. This would be useful when the multiple DRBs are configured for a single service type.

Various embodiments also allow the collection of excess delay measurements on a per network slice per DRB level. As an example, two network slices may support video services. The video services of each slice may be served by DRBs with identical characteristics. However, in one Network Slice, video services are critical services and for that they should be subject to very low transmission delays, while in the other Network slice video services are for entertainment purposes and for that more tolerant to transmission delays.

According to some other embodiments, a method performed by a radio access network, RAN, node to configure a wireless device to perform and report uplink packet data convergence protocol, PDCP, excess delay measurements is provided. The method includes configuring the wireless device with an excess delay configuration to perform uplink PDCP excess delay measurements, the excess delay configuration including a list of PDCP excess delay thresholds associated with data radio bearer, DRB, identities, IDs. The method further includes receiving an excess delay measurement report from the wireless device based on the excess delay configuration, the excess delay measurement report including a list of PDCP excess delay measurements. The method further includes performing at least one action based on the excess delay measurement report.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is an illustration of an overall NG-RAN architecture;

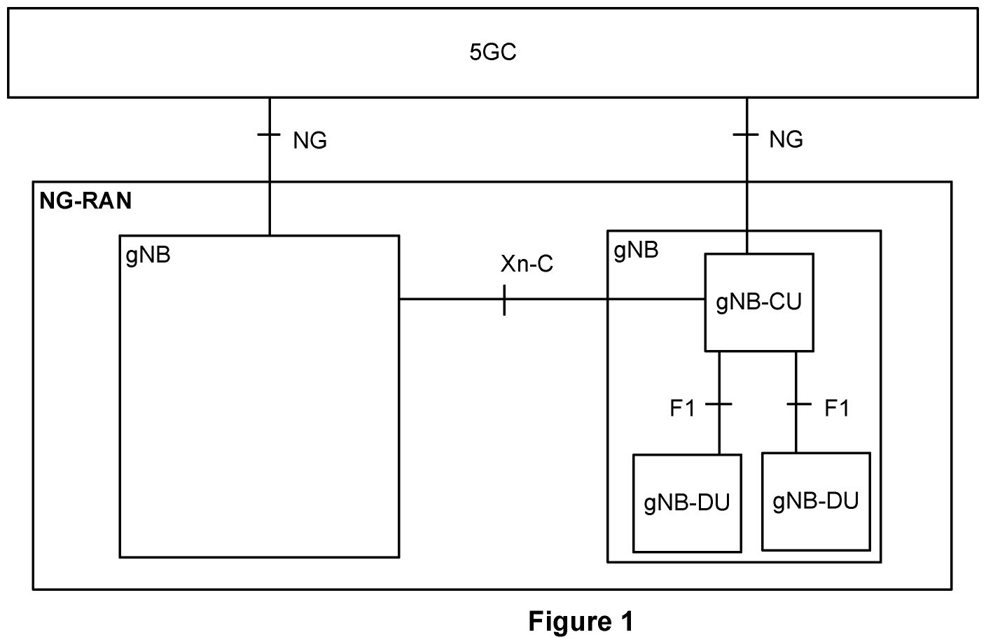

FIG. 2 is an illustration of a split gNB architecture in NG-RAN;

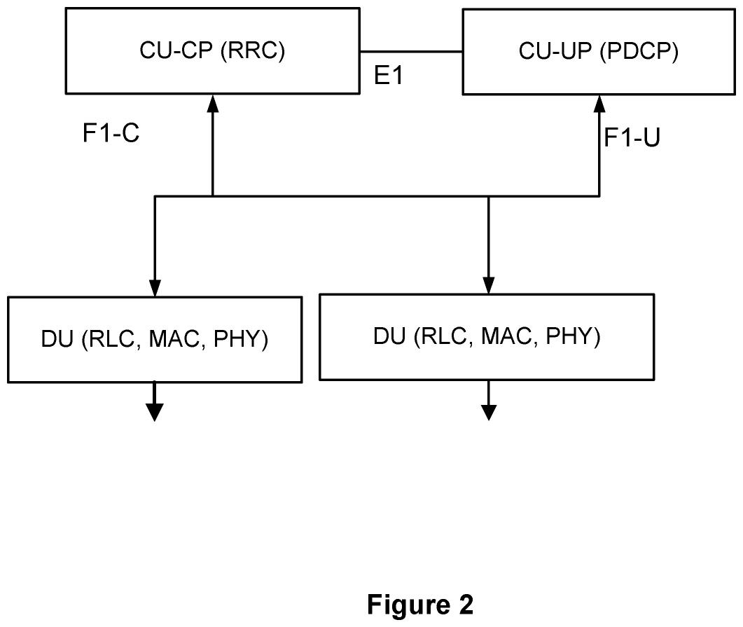

FIGS. 3-6 are flowchart illustrating operations of a RAN node according to various embodiments;

FIGS. 7-8 are flow charts illustrating operations of a wireless device according to various embodiments;

FIG. 9 is a block diagram of a communication system in accordance with some embodiments;

FIG. 10 is a block diagram of a user equipment in accordance with some embodiments

FIG. 11 is a block diagram of a network node in accordance with some embodiments;

FIG. 12 is a block diagram of a host computer communicating with a user equipment in accordance with some embodiments;

FIG. 13 is a block diagram of a virtualization environment in accordance with some embodiments; and

FIG. 14 is a block diagram of a host computer communicating via a base station with a user equipment over a partially wireless connection in accordance with some embodiments in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

As previously indicated, in LTE, as part of total RAN delay measurements, UE performs packet delay measurement in the uplink direction. Prior to describing the various embodiments, the LTE delay measurements shall first be described.

### UL PDCP Packet Delay Per QCI

The objective of this measurement performed by UE is to measure Excess Packet Delay Ratio in Layer PDCP for QoS verification of MDT.

### Protocol Layer: RLC, PDCP

| | |
|---|---|
| Definition | PDCP Packet Delay in the UL per QCI. This |
| | measurement refers to packet delay for DRBs, which |
| | captures the delay from packet arrival at PDCP upper |
| | SAP until the packet starts to be delivered to RLC. |
| | The measurement is done separately per QCI. |
| | Detailed Definition: |
| | $M ( T , qci ) = \frac{nExcess ( T , qci )}{nTotal ( T , qci )} ,$ |
| | where tULdelay (i, qci) = tDeliv(i, qci) − tArrival (i, qci) |
| | explanations can be found in the table 4.2.1.1-1 below. |
| M (T, qci) | Ratio of packets in UL per QCI exceeding the |
| | configured delay threshold among the UL PDCP |
| | service data units (SDUs) transmitted. |
| nExcess(T, qci) | Number of PDCP SDUs of a data radio bearer |
| | with QCI = qci, for which ULdelay |
| | tULdelay(i, qci) exceeded the configured |
| | delayThreshold as defined in TS 36.331 [5] |
| | during the time period T. |
| nTotal(T, qci) | Number of PDCP SDUs of a data radio bearer |
| | with QCI = qci, for which at least a part of SDU |
| | was transmitted during the time period T. |
| tULdelay(i, qci) | Queuing delay observed at the UE PDCP layer |
| | from packet arrival at PDCP upper SAP until the |
| | packet starts to be delivered to RLC, the packet |
| | belongs to a data radio bearer with QCI = qci. |
| tDeliv (i, qci) | The point in time when the PDCP SDU I of a data |
| | radio bearer with QCI = qci was delivered to |
| | lower layers. |
| tArrival(i, qci) | The point in the time when the PDCP SDU I of a |
| | data radio bearer with QCI = qci arrives at |
| | PDCP upper SAP. |
| i | Index of PDCP SDU that arrives at the PDCP |
| | upper SAP during time period T . |
| T | Time period during which the measurement is |
| | performed. |

### Measurement Report Mapping for PDCP SDU Queuing Delay

UL PDCP SDU queuing delay shall be measured according to configuration as defined in TS 36.331 [5].

The UE shall report UL PDCP SDU queuing delay as the ratio of SDUs exceeding the configured delay threshold and the total number of SDUs received by the UE during the measurement period.

The reported excess PDCP queuing delay ratio is mapped to 32 levels with the quantities in the range of 0<nExcess≤100% with uniform quantization in the log domain.

The mapping of measured quantity is defined in Table 4.2.1.1.1-1, which is reproduced below.

TABLE 4.2.1.1.1-1
EXCESS DELAY RATIO measurement report mapping (5 -bit value)

| Reported value | Measured quantity value | Unit |
|---|---|---|
| EXCESS DELAY RATIO_00 | 0 < EXCESS DELAY RATIO □ 0,079 | % |
| EXCESS DELAY RATIO_01 | 0,079 < EXCESS DELAY RATIO □ 0,100 | % |
| EXCESS DELAY RATIO_02 | 0,100 < EXCESS DELAY RATIO □0,126 | % |
| EXCESS DELAY RATIO_03 | 0,126 < EXCESS DELAY RATIO □ 0,158 | % |
| EXCESS DELAY RATIO_04 | 0,158 < EXCESS DELAY RATIO □ 0,199 | % |
| EXCESS DELAY RATIO_05 | 0,199 < EXCESS DELAY RATIO □ 0,251 | % |
| EXCESS DELAY RATIO_06 | 0,251 < EXCESS DELAY RATIO □ 0,316 | % |
| EXCESS DELAY RATIO_07 | 0,316 < EXCESS DELAY RATIO □ 0,398 | % |
| EXCESS DELAY RATIO_08 | 0,398 < EXCESS DELAY RATIO □ 0,501 | % |
| EXCESS DELAY RATIO_09 | 0,501 < EXCESS DELAY RATIO □ 0,631 | % |
| EXCESS DELAY RATIO_10 | 0,631 < EXCESS DELAY RATIO □ 0,794 | % |
| EXCESS DELAY RATIO_11 | 0,794 < EXCESS DELAY RATIO □ 1,000 | % |
| EXCESS DELAY RATIO_12 | 1,000 < EXCESS DELAY RATIO □ 1,259 | % |
| EXCESS DELAY RATIO_13 | 1,259 < EXCESS DELAY RATIO □ 1,585 | % |
| EXCESS DELAY RATIO_14 | 1,585 < EXCESS DELAY RATIO □ 1,995 | % |
| EXCESS DELAY RATIO_15 | 1,995 < EXCESS DELAY RATIO □ 2,511 | % |
| EXCESS DELAY RATIO_16 | 2,511 < EXCESS DELAY RATIO □ 3,161 | % |
| EXCESS DELAY RATIO_17 | 3,161 < EXCESS DELAY RATIO □ 3,980 | % |
| EXCESS DELAY RATIO_18 | 3,980 < EXCESS DELAY RATIO □ 5,011 | % |
| EXCESS DELAY RATIO_19 | 5,011 < EXCESS DELAY RATIO □ 6,309 | % |
| EXCESS DELAY RATIO_20 | 6,309 < EXCESS DELAY RATIO □ 7,943 | % |
| EXCESS DELAY RATIO_21 | 7,943 < EXCESS DELAY RATIO □ 10,00 | % |
| EXCESS DELAY RATIO_22 | 10,00 < EXCESS DELAY RATIO □ 12,589 | % |
| EXCESS DELAY RATIO_23 | 12,589 < EXCESS DELAY RATIO □ 15,849 | % |
| EXCESS DELAY RATIO_24 | 15,849 < EXCESS DELAY RATIO □ 19,953 | % |
| EXCESS DELAY RATIO_25 | 19,953 < EXCESS DELAY RATIO □ 25,119 | % |
| EXCESS DELAY RATIO_26 | 25,119 < EXCESS DELAY RATIO □ 31,623 | % |
| EXCESS DELAY RATIO_27 | 31,623 < EXCESS DELAY RATIO □ 39,811 | % |
| EXCESS DELAY RATIO_28 | 39,811 < EXCESS DELAY RATIO □ 50,119 | % |
| EXCESS DELAY RATIO_29 | 50,119 < EXCESS DELAY RATIO □ 63,096 | % |
| EXCESS DELAY RATIO_30 | 63,096 < EXCESS DELAY RATIO □ 79,433 | % |
| EXCESS DELAY RATIO_31 | 79,433 < EXCESS DELAY RATIO □ 100 | % |

### Configuration of Delay Measurement

The configuration and relevant threshold is sent by the network as specified in TS 36.331

### UL-DelayConfig

The IE UL-DelayConfig IE specifies the configuration of the UL PDCP Packet Delay per QCI measurement specified in TS 36.314

### UL-DelayConfig Information Element

| | |
|---|---|
| -- ASN1START | |
| UL-DelayConfig-r13 ::= | CHOICE { |
| release | NULL, |
| setup | SEQUENCE { |
| delayThreshold-r13 | ENUMERATED { |
| | ms30, ms40, ms50, ms60, ms70, ms80, |
| | ms90, ms100, ms150, ms300, ms500, ms750, |
| spare4, | |
| | spare3, spare2, spare1 } |
| } | |
| } | |
| -- ASN1STOP | |

UL-DelayConfig field descriptions

delayThreshold
Indicates the delay threshold value used by UE to provide
results of UL PDCP Packet Delay per
QCI measurement as specified in TS 36.314 [2]. Value in
milliseconds. Value ms30 means 30 ms and so on.

As previously indicated, in NR, the PDCP delay calculation can be configured for certain DRBs and the DRBs can be mapped to a wide range of physical layer resources. It is not feasible to set one threshold value that can effectively represent excess delay for DRBs that are mapped to high frequency physical channels and DRBs that are mapped to low frequency physical channels. For example, with the existing approach, a URLLC related DRB and a MBB related DRB need to be configured with the same delay threshold configuration which is not ideal from an operator's flexibility point of view when it comes to QoS related measurement collection from the UE.

Additionally, it is difficult with such configuration to trigger network specific actions in the case when the excess delay ratio exceeds certain limits. As an example, certain services may be able to tolerate higher excess delays and for that they should not be subject to specific network actions when the excess delay ratio increases, while other services may drastically suffer from increased excess delay ratio increases and for that the network may need to take actions to reduce such delays.

Various embodiments described herein allow the network to set thresholds to calculate excess delay in a flexible manner and thus the result reported by the UE reflects delay measurements that is reflective of a use case, like URLLC or MBB. In addition, the solution enables the RAN node to configure the excess delay measurements per DRB characteristics. This would be useful when the multiple DRBs are configured for a single service type. For example, for a URLLC type of services (interactive Virtual Reality application) DRB #1 can be configured for the voice packets and DRB #2 can be configured for the video packets. Hence, the characteristics of the data traffic over DRB #1 (conveying real time voice packets) and DRB #2 (conveying real time video packets) can be significantly different and hence based on their characteristics different excess delay thresholds can be set for these DRBs.

The various embodiments also allow the collection of excess delay measurements on a per network slice per DRB level. As an example, two network slices may support video services. The video services of each slice may be served by DRBs with identical characteristics. However, in one Network Slice, video services are critical services and for that they should be subject to very low transmission delays, while in the other Network slice video services are for entertainment purposes and for that more tolerant to transmission delays. The solution allows for differentiation of the excess delay threshold values on a per Network Slice basis, so to achieve better granularity in the detection of issues that may undermine quality of experience and service level agreements.

Thus, the various embodiments receive excess delay configurations (including a list of delay thresholds associated with the DRB IDs/S-NSSAIs) by the RAN node (e.g., a gNB) from another entity (e.g., from core network or from the OAM), and configure the UE with a list of thresholds applicable for different DRB or DRB ranges to calculate excess delay values. The wireless device (e.g., UE) may use one configured threshold value for calculating excess delay for a multitude of lists where each list may contain a single or multitude of DRBs/S-NSSAIs. The wireless device reports the list of the performed excess delay measurements associated with the DRB IDs/S-NSSAIs to the network node which then use it for per DRB optimization. The RAN node receiving the list of excess delay measurements forwards the report to the other network entities such as core network (e.g., access and mobility management function (AMF)), the Distributed Unit (DU), the gNB-CU-UP, the operations, administration, and maintenance (OAM), etc. for further network optimization.

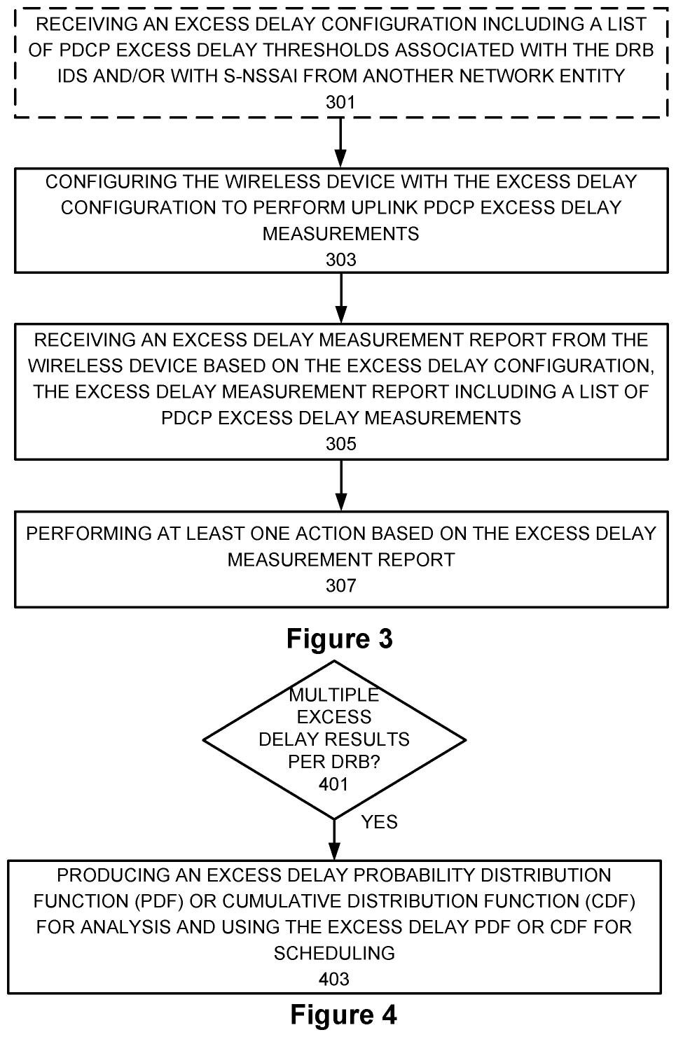

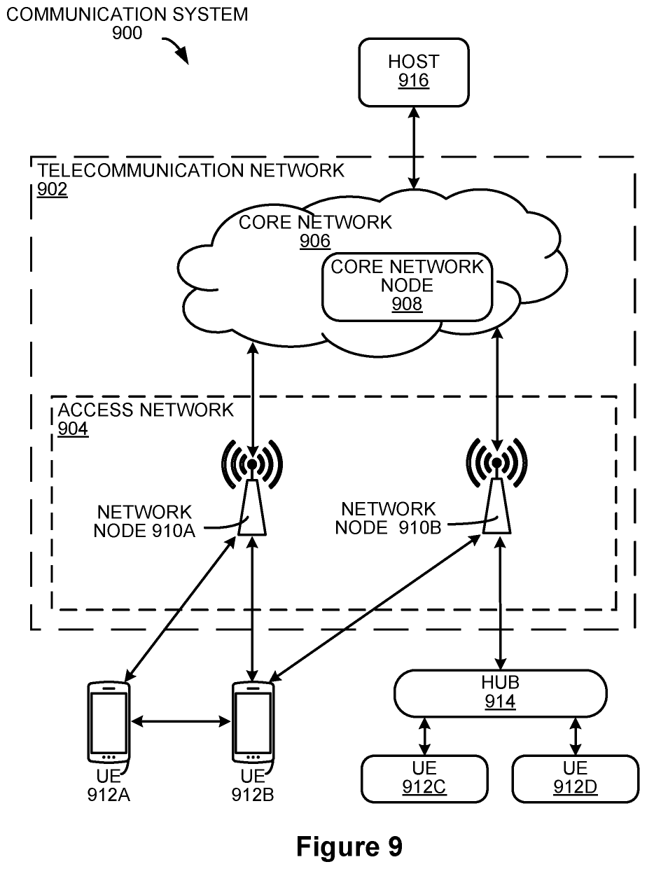

Operations of the RAN node 1100 (implemented using the structure of FIG. 11) will now be discussed with reference to the flow chart of FIG. 3 according to some embodiments of inventive concepts. For example, modules may be stored in memory 1104 of FIG. 11, and these modules may provide instructions so that when the instructions of a module are executed by respective RAN node processing circuitry 1102, RAN node 1100 performs respective operations of the flow chart.

FIG. 3 illustrates a method performed by a network node (e.g., a radio access network (RAN) node 1100) to configure a wireless device 1000 (also referred to as a user equipment or UE) with a configuration to perform and report uplink PDCP excess delay measurements.

Turning to FIG. 3, in optional block 301, the RAN node 1100 receives an excess delay configuration including a list of PDCP thresholds associated with data radio bearer, DRB, identifications, IDs, and/or with single-network slice selection assistance information, S-NSSAI, from another network entity. The other network entity could be a core network element (e.g., an AMF, another radio access network node, or from an operations, administration, and maintenance, OAM, node.

In some embodiments, the RAN node 1100 receives, additionally to the per DRB configuration or in alternative to it, a configuration of the network slices, each identified by an S-NSSAI, for which excess delay measurements shall be performed, together with excess delay measurements thresholds per S-NSSAI. hen receiving a list of S-NSSAIs, each S-NSSAI being associated with an excess delay threshold value, the RAN configures the UE with an excess delay measurement for each active DRB associated to one of the S-NSSAI in the list. For all the DRBs associated to an S-NSSAI, the excess delay threshold associated to the S-NSSAI will be applied during the excess delay measurement process.

In some embodiments, the excess delay configuration may be received as part of the minimization of drive test (MDT) configuration. This can be achieved as enhancements of an existing MDT measurement configuration (e.g., as an enhancement of the M6 delay measurement configuration) or as part of a new measurement configuration. Such a configuration can be signaled from the OAM to the RAN node directly, in case of management-based MDT, or via the AMF in case of signalling based MDT. In this case, the configuration is complemented with details such as the trace identifier (e.g., the NG-RAN Trace ID IE signaled over the NG application protocol (NGAP)), which is used by the wireless device to create a measurement report associated to the trace identifier, which will be signaled to the OAM.

In some embodiments, the excess delay configuration consists of a list of data radio bearer, DRB, identities, IDS, for which the wireless device is to perform the PDCP excess delay measurements.

In other embodiments, the excess delay configuration consists of a list of thresholds associated with the DRB IDs for which the wireless device is to perform the PDCP excess delay measurements.

In yet other embodiments, the excess delay configuration consists of a map between the DRB IDs and the list of thresholds. In some of these embodiments, the mapping consists of a one-to-one relation between the elements of the list of DRBs and the list of thresholds, i.e., every DRB is assigned a separate threshold value.

In some other embodiments, the configuration consists of a list of thresholds, each associated to an S-NSSAI, using which the UE needs to calculate the UL PDCP excess delay measurements.

In further embodiments, the configuration consists of a one-to-many relation between the elements of the list of DRBs or S-NSSAIs or both and the list of thresholds. Examples of the one-to-many relation is:
1. One threshold value can be applicable for more than one DRB/S-NSSAI.
2. One DRB/S-NSSAI can be configured with more than one threshold values. The later would allow for the reporting by the UE of multiple excessive delay results, each taken with respect to one of the excess delay threshold values configured.

In block 303, the RAN node 1100 configures the wireless device 1000 with the excess delay configuration to perform uplink PDCP excess delay measurements. The excess delay configuration may be one or more of the embodiments discussed above.

In block 305, the RAN node 1100 receives an excess delay measurement report from the wireless device based on the excess delay configuration, the excess delay measurement report including a list of PDCP excess delay measurements.

In some embodiments, the RAN node 1100 receives the excess delay measurement report as part of a minimization of drive test, MDT, report. In some other embodiments, the RAN node 1100 receives the excess delay measurement report as part of a radio resource management, RRM, measurement report.

FIG. 4 illustrates an embodiment where the excess delay measurement report contains multiple excess delay results per DRB/S-NSSAI.

Turning to FIG. 4, responsive to the excess delay measurement report containing multiple excess delay results per data radio bearer, DRB/single-network slice selection assistance information, S-NSSAI as determined in block 401, the RAN node 1100, in block 403 produces an excess delay probability distribution function (PDF) or cumulative distribution function (CDF) for analysis and uses the excess delay PDF or CDF for scheduling.

In block 307, the RAN node 1100 performs at least on action based on the excess delay measurement report.

FIG. 5 illustrates various embodiments of performing at least one action.

Turning to FIG. 5, in block 501, the RAN node 1100 performs the at least one action by forwarding the excess delay measurement report including the list of PDCP excess delay measurements associated with data radio bearer, DRB, identifications, IDs, towards other network entities. The other network entities can be at least one of a core network element such as an access and mobility management function, AMF, or a user plane function, UPF, another RAN node, a distributed unit in a split RAN architecture, and/or an operations, administration, and management system.

In some embodiments, forwarding the excess delay measurement report comprises combining the excess delay measurement report with other reports to produce a combined measurement report and transmitting the combined measurement report towards the other entities. In some of these embodiments, the RAN node 1100 combines the excess delay measurement report with other reports by combining the excess delay measurement report with one or more of an over-the-air excess delay report, an internal excess delay report and an interface excess delay report. The nodes and systems receiving the measurements will become aware of the excess delay ratio and deduce whether any issue detected can be conducted to the excess delay ratio values.

In block 503, the RAN node 1100 performs the at least one action by signaling a radio access network, RAN, node hosting PDCP with one or more of: the excess delay measurement report; an indication that an excess delay ratio exceeds a threshold; and an indication that the excess delay ratio is above or below acceptable limits.

The gNB-CU-UP in the RAN node hosting PDCP may take measures to reduce the excess delay. As an example, one of such measures may be to throttle UL traffic for the affected QoS DRBs. Such throttling action will produce a reduction of UL traffic rate at application level (e.g., by means of a reduction of the TCP transmission window) and by that it may ease the issue of excessive UL traffic entering PDCP and causing the excessive delay ratios.

A gNB-CU-CP receiving the excess delay measurements may signal one or more of the following to the gNB-DU:
the excess delay measurement report
an indication of the fact that the excess delay ratio exceeds a certain threshold and/or
an indication that the excess delay ratio is above acceptable limits or below certain limits

The gNB-DU may take a number of actions, for example, if the delay exceeds the QoS parameters set for the associated DRB, or if the excess delay is deemed too high, the gNB-DU may decide to increase the scheduling priority of the DRB UL traffic and/or increase the transmission rate in UL for the affected DRBs.

In block 505, the RAN node 1100 performs the at least one action by triggering an indication towards a core network to indicate that the quality of service, QoS, for the protocol data unit (PDU) Sessions whose traffic is affected by poor excess delay ratio does not meet the requested QoS levels previously required by the core network or the RAN for the UE in question. As an example, the gNB-CU-CP of the RAN node may determine whether the protocol data unit (PDU) Session quality of service (QoS) is fulfilled or not on the basis of the excess delay measurements received from the wireless device. If not, the gNB-CU may trigger a PDU Session Notify message to the AMF, indicating that the PDU Session QoS is not fulfilled and specifying that the cause is that excess delay ratios are too high.

FIG. 6 illustrates an embodiment where the excess delay measurement report indicates excess delay is above a threshold.

Turning to FIG. 6, responsive to the excess delay measurement report indicating excess delay is above a threshold value as determined by the RAN node 1100 in block 601, the RAN node 1100 in block 603 performs one or more of: increasing a scheduling priority; increasing a transmission rate in the UL for affected DRBs; throttling UL traffic for affected QoS DRBs; and/or reallocating radio resources to minimize measured excess delay per each DRB

In some embodiments, the RAN node 1100 reallocates the radio resources by reallocating the radio resources among DRBs to minimize measured excess delay and expected delay per each DRB.

In some embodiments a DU can send an indication to the RAN node 1100 that is in charge to configure the wireless device with excess delay measurement) to trigger/initiate and/or stop the excess delay measurement at the wireless device. This can be useful for the DU to enable the excess delay measurement whenever necessary. Thus, the RAN node 1100 can transmit an indication to the wireless device to initiate an excess delay measurement and transmit an indication to the wireless device to stop an excess delay measurement. When the RAN node is operating in a split RAN architecture, the distributed unit in the split RAN architecture can transmit an indication to the centralized unit in the split RAN architecture to initiate the excess delay measurement or to stop the excess delay measurement.

The CU-CP that receives an excess delay measurement report from the wireless device may forwards this measurement report to the CU-UP. CU-UP then receives additional reports from the DU associated to excess delay measurements for over-the-air excess delay, DU internal excess delay and F1-U excess delay. The CU-UP calculates the CU-UP internal excess delay on its own. In some sub-embodiments, the CU-UP combines these excess delay measurements into a single excess delay measurement and share it with the core network (UPF). How to combine the individual delay measurement into a single delay measurement can be derived based on the principles applied to combine the average delay measurement (D1) or any other method. In some other embodiments, the CU-UP shares each of these excess delay measurements with the core network

Various operations from the flow chart of FIG. 3 may be optional with respect to some embodiments of RAN nodes and related methods. Regarding methods of example embodiment 1 (set forth below), for example, operations of block 301 of FIG. 3 may be optional.

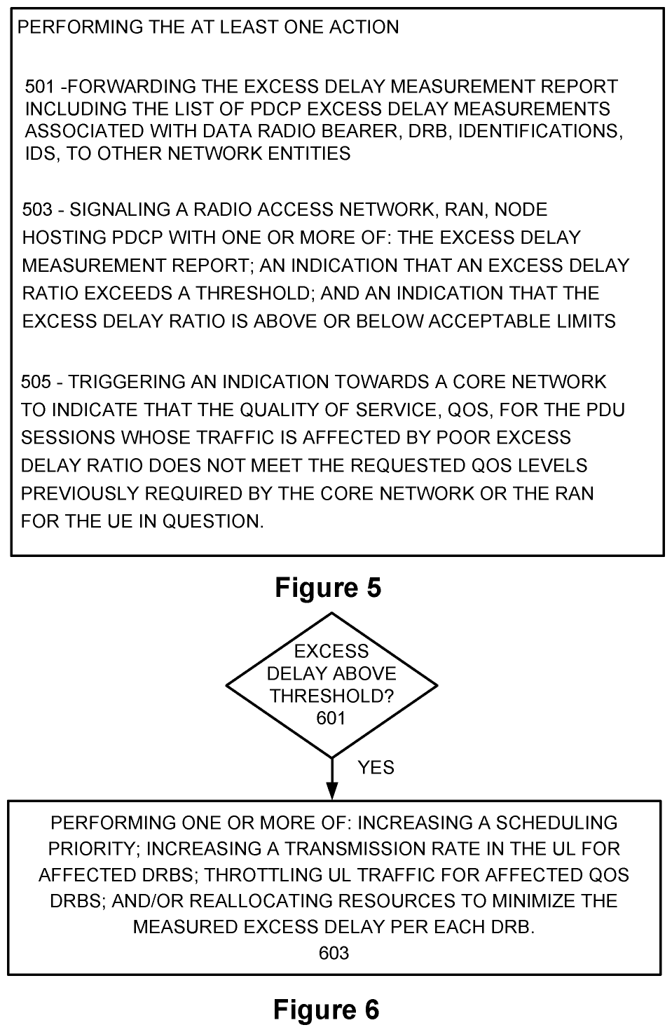

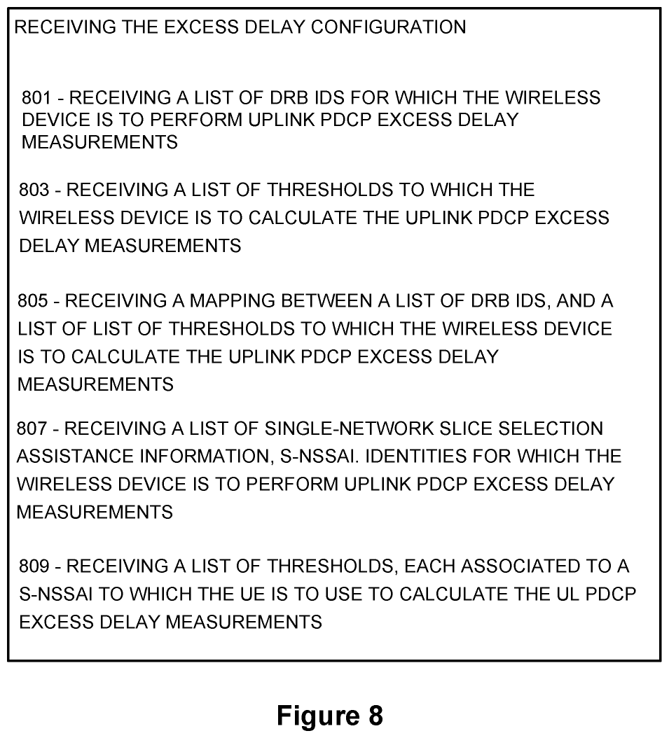

Operations of the wireless device 1000 (implemented using the structure of the block diagram of FIG. 10) will now be discussed with reference to the flow chart of FIG. 7 according to some embodiments of inventive concepts. For example, modules may be stored in memory 1010 of FIG. 10, and these modules may provide instructions so that when the instructions of a module are executed by respective communication device processing circuitry 1002, processing circuitry 1002 performs respective operations of the flow chart.

FIG. 7 illustrates a method by a wireless device to receive an excess delay measurement configuration from a serving radio access network node and perform measurements according to the excess delay configuration.

Turning to FIG. 7, in block 701, the wireless device 1100 receives an excess delay configuration to perform uplink PDCP excess delay measurements.

FIG. 8 illustrates various embodiments of receiving the excess delay configuration.

In some embodiments illustrated by block 801, the wireless device 1100 receives the excess delay configuration by receiving a list of data radio bearer, DRB, identities, IDs, for which the wireless device is to perform uplink PDCP excess delay measurements.

In some embodiments illustrated by block 803, the wireless device 1100 receives the excess delay configuration by receiving a list of thresholds to which the wireless device is to calculate the uplink PDCP excess delay measurements. The list of thresholds is associated with a list of data radio bearer, DRB, identities, IDs.

In some embodiments illustrated by block 805, the wireless device 1100 receives the excess delay configuration by receiving a mapping between a list of data resource bearer, DRB, identities, IDs, and a list of thresholds to which the wireless device is to calculate the uplink PDCP excess delay measurement. In some of these embodiments, the mapping consists of a one-to-one relation between elements in the list of DRB IDs and the list of thresholds.

In some embodiments illustrated by block 807, the wireless device 1100 receives the excess delay configuration by receiving a list of single-network slice selection assistance information, S-NSSAL. Identities entity for which the wireless device is to perform uplink PDCP excess delay measurements.

In some embodiments illustrated by block 809, the wireless device 1100 receives the excess delay configuration by receiving a list of thresholds, each associated to a single-network slice selection assistance information, S-NSSAI, to which the UE is to use to calculate the UL PDCP excess delay measurements.

In some of the embodiments of block 807 and 809, the excess delay configuration is a one-to-many relation between elements of a list of data resource bearer DRBs identifications, IDs, or S-NSSAIs or the list of thresholds of the list of DRB IDs and S-NSSAIs and the list of thresholds. Examples of the one-to-many relation is:
One threshold value can be applicable for more than one DRB/S-NSSAI.
One DRB/S-NSSAI can be configured with more than one threshold values. The later would allow for the reporting by the UE of multiple excessive delay results, each taken with respect to one of the excess delay threshold values configured

In some of the above embodiments and/or in other embodiments, the wireless device 1100 receives the excess delay configuration as part of a minimization of drive test configuration.

Returning to FIG. 7, in block 703, the wireless device 1100 may receive a trigger to perform uplink PDCP excess delay measurements.

In block 705, the wireless device 1100 performs uplink PDCP excess delay measurements based on threshold values in the excess delay configuration. Thus, the wireless device 1100 performs UL PDCP delay measurements for the configured DRBs and/or S-NSSAIs and in some embodiments, calculates the excess delay values based on the associated thresholds. In some embodiments, the wireless device 1100 performs uplink PDCP excess delay measurements after the wireless device 1100 receives the excess delay configuration. Alternatively, or additionally, the wireless device 1100 performs uplink PDCP excess delay measurements responsive to receiving the trigger to perform uplink PDCP excess delay measurements.

In block 707, the wireless device 1100 transmits an excess delay measurement report to the serving radio access network, RAN, node, the excess delay measurement report including a list of PDCP excess delay measurements.

In some embodiments, the excess delay configuration may have multiple threshold values for a single DRB/S-NSSAI. The wireless device, responsive to the excess delay configuration having multiple threshold values related to a single DRB or S-NSSAI, includes all excess delay measurements in a list associating with the single DRB/NSSAI and includes the list in or with the excess delay measurement report. In some of these embodiments, an order of elements in the list refers to an order of the threshold values configured by the network. The wireless device 1100 may include the threshold values and excess delay values in the list.

Various operations from the flow chart of FIG. 7 may be optional with respect to some embodiments of communication devices and related methods. Regarding methods of example embodiment 18 (set forth below), for example, operations of block 703 of FIG. 7 may be optional.

### Example Implementation

In the following, a non-limiting example of the configuration (301) in TS 38.331 is provided. In this example, the delayThreshold configured in the drb-IdentityList of one element of UL-ExcessDelayValueConfig list is applicable for all the DRBs configured in the drb-IdentityList of the same element of UL-ExcessDelayValueConfig list.

### UL-ExcessDelayValueConfig Information Element

-- ASN1START
-- TAG-ULEXCESSDELAYVALUECONFIG-START
UL-ExcessDelayValueConfig-rxy ::= SEQUENCE (SIZE(1..maxDRB)) OF DRB-Identity Info

| | |
|---|---|
| DRB-IdentityInfo ::= | SEQUENCE { |
| drb-IdentityList | SEQUENCE (SIZE (1..maxDRB)) OF DRB-Identity, |
| delayThreshold | ENUMERATED { |
| | ms30, ms40, ms50, ms60, ms70, ms80, |
| | ms90, ms100, ms150, ms300, ms500, ms750, spare4, |
| | spare3, spare2, spare1} |
| } | |

-- TAG-ULEXCESSDELAYVALUECONFIG-STOP
-- ASN1STOP

Another non-limiting example of the report from UE where network has configured UE with multiple thresholds to calculate excess delay ratio per DRB is provided below:

UL-PDCP-ExcessDelayValueResultList-rxx ::= SEQUENCE (SIZE (1..maxDRB)) OF UL-
PDCP-ExcessDelayValueResult-rxx

| UL-PDCP-DelayValueResult-rx ::= | | SEQUENCE { |
|---|---|---|
| drb-Id-rxx | | DRB-Identity, |
| excessDelayList-rxx | SEQUENCE (SIZE (1..maxDRB)) OF excessDelay-rxx, | |
| ... | | |
| } | | |
| excessDelay-rxx | | INTEGER (0..31) |

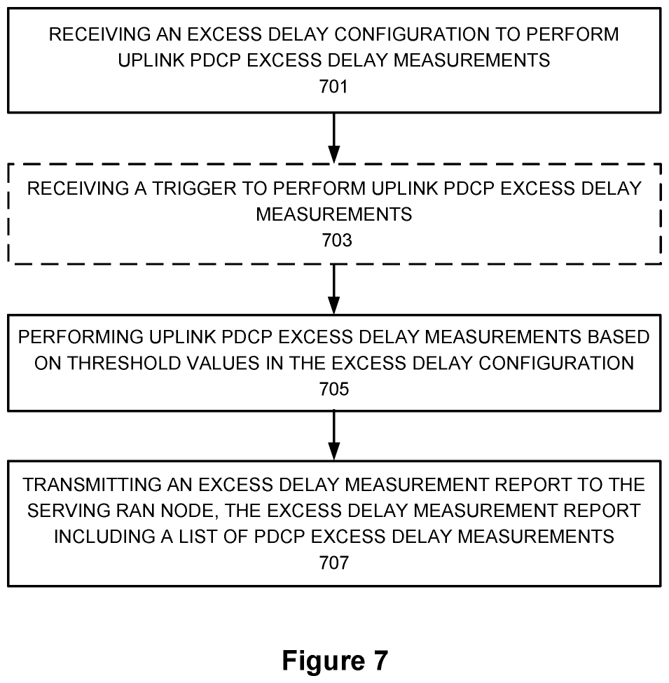

FIG. 9 shows an example of a communication system 900 in accordance with some embodiments.

In the example, the communication system 900 includes a telecommunication network 902 that includes an access network 904, such as a radio access network (RAN), and a core network 906, which includes one or more core network nodes 908. The access network 904 includes one or more access network nodes, such as network nodes 910A and 910B (one or more of which may be generally referred to as network nodes 910), or any other similar 3^{rd} Generation Partnership Project (3GPP) access node or non-3GPP access point. The network nodes 910 facilitate direct or indirect connection of user equipment (UE), such as by connecting UEs 912A, 912B, 912C, and 912D (one or more of which may be generally referred to as UEs 912) to the core network 906 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The UEs 912 may be any of a wide variety of communication devices, including wireless devices arranged, configured, and/or operable to communicate wirelessly with the network nodes 910 and other communication devices. Similarly, the network nodes 910 are arranged, capable, configured, and/or operable to communicate directly or indirectly with the UEs 912 and/or with other network nodes or equipment in the telecommunication network 902 to enable and/or provide network access, such as wireless network access, and/or to perform other functions, such as administration in the telecommunication network 902.

In the depicted example, the core network 906 connects the network nodes 910 to one or more hosts, such as host 916. These connections may be direct or indirect via one or more intermediary networks or devices. In other examples, network nodes may be directly coupled to hosts. The core network 906 includes one more core network nodes (e.g., core network node 909) that are structured with hardware and software components. Features of these components may be substantially similar to those described with respect to the UEs, network nodes, and/or hosts, such that the descriptions thereof are generally applicable to the corresponding components of the core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 916 may be under the ownership or control of a service provider other than an operator or provider of the access network 904 and/or the telecommunication network 902 and may be operated by the service provider or on behalf of the service provider. The host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 900 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 902 is a cellular network that implements 3GPP standardized features. Accordingly, the telecommunications network 902 may support network slicing to provide different logical networks to different devices that are connected to the telecommunication network 902. For example, the telecommunications network 902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio—Dual Connectivity (EN-DC).

In the example, the hub 914 communicates with the access network 904 to facilitate indirect communication between one or more UEs (e.g., UE 912C and/or 912D) and network nodes (e.g., network node 910B). In some examples, the hub 914 may be a controller, router, content source and analytics, or any of the other communication devices described herein regarding UEs. For example, the hub 914 may be a broadband router enabling access to the core network 906 for the UEs. As another example, the hub 914 may be a controller that sends commands or instructions to one or more actuators in the UEs. Commands or instructions may be received from the UEs, network nodes 910, or by executable code, script, process, or other instructions in the hub 914. As another example, the hub 914 may be a data collector that acts as temporary storage for UE data and, in some embodiments, may perform analysis or other processing of the data. As another example, the hub 914 may be a content source. For example, for a UE that is a VR headset, display, loudspeaker or other media delivery device, the hub 914 may retrieve VR assets, video, audio, or other media or data related to sensory information via a network node, which the hub 914 then provides to the UE either directly, after performing local processing, and/or after adding additional local content. In still another example, the hub 914 acts as a proxy server or orchestrator for the UEs, in particular in if one or more of the UEs are low energy IoT devices.

The hub 914 may have a constant/persistent or intermittent connection to the network node 910B. The hub 914 may also allow for a different communication scheme and/or schedule between the hub 914 and UEs (e.g., UE 912C and/or 912D), and between the hub 914 and the core network 906. In other examples, the hub 914 is connected to the core network 906 and/or one or more UEs via a wired connection. Moreover, the hub 914 may be configured to connect to an M2M service provider over the access network 904 and/or to another UE over a direct connection. In some scenarios, UEs may establish a wireless connection with the network nodes 910 while still connected via the hub 914 via a wired or wireless connection. In some embodiments, the hub 914 may be a dedicated hub—that is, a hub whose primary function is to route communications to/from the UEs from/to the network node 910B. In other embodiments, the hub 914 may be a non-dedicated hub—that is, a device which is capable of operating to route communications between the UEs and network node 910B, but which is additionally capable of operating as a communication start and/or end point for certain data channels.

FIG. 10 shows a UE 1000 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1000 includes processing circuitry 1002 that is operatively coupled via a bus 1004 to an input/output interface 1006, a power source 1008, a memory 1010, a communication interface 1012, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 1002 is configured to process instructions and data and may be configured to implement any sequential state machine operative to execute instructions stored as machine-readable computer programs in the memory 1010. The processing circuitry 1002 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1002 may include multiple central processing units (CPUs).

In the example, the input/output interface 1006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1000. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1008 is structured as a battery or battery pack. Other types of power sources, such as an external power source (e.g., an electricity outlet), photovoltaic device, or power cell, may be used. The power source 1008 may further include power circuitry for delivering power from the power source 1008 itself, and/or an external power source, to the various parts of the UE 1000 via input circuitry or an interface such as an electrical power cable. Delivering power may be, for example, for charging of the power source 1008. Power circuitry may perform any formatting, converting, or other modification to the power from the power source 1008 to make the power suitable for the respective components of the UE 1000 to which power is supplied.

The memory 1010 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1010 includes one or more application programs 1014, such as an operating system, web browser application, a widget, gadget engine, or other application, and corresponding data 1016. The memory 1010 may store, for use by the UE 1000, any of a variety of various operating systems or combinations of operating systems.

The memory 1010 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1010 may allow the UE 1000 to access instructions, application programs and the like, stored on transitory or non-transitory memory media, to off-load data, or to upload data. An article of manufacture, such as one utilizing a communication system may be tangibly embodied as or in the memory 1010, which may be or comprise a device-readable storage medium.

The processing circuitry 1002 may be configured to communicate with an access network or other network using the communication interface 1012. The communication interface 1012 may comprise one or more communication subsystems and may include or be communicatively coupled to an antenna 1022. The communication interface 1012 may include one or more transceivers used to communicate, such as by communicating with one or more remote transceivers of another device capable of wireless communication (e.g., another UE or a network node in an access network). Each transceiver may include a transmitter 1018 and/or a receiver 1020 appropriate to provide network communications (e.g., optical, electrical, frequency allocations, and so forth). Moreover, the transmitter 1018 and receiver 1020 may be coupled to one or more antennas (e.g., antenna 1022) and may share circuit components, software or firmware, or alternatively be implemented separately.

In the illustrated embodiment, communication functions of the communication interface 1012 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1012, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected, an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1000 shown in FIG. 10.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 11 shows a network node 1100 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1100 includes a processing circuitry 1102, a memory 1104, a communication interface 1106, and a power source 1108. The network node 1100 may be composed of multiple physically separate components (e.g., a NodeB component and a RNC component, or a BTS component and a BSC component, etc.), which may each have their own respective components. In certain scenarios in which the network node 1100 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1100 may be configured to support multiple radio access technologies (RATs). In such embodiments, some components may be duplicated (e.g., separate memory 1104 for different RATs) and some components may be reused (e.g., a same antenna 1110 may be shared by different RATs). The network node 1100 may also include multiple sets of the various illustrated components for different wireless technologies integrated into network node 1100, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1100.

The processing circuitry 1102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1100 components, such as the memory 1104, to provide network node 1100 functionality.

In some embodiments, the processing circuitry 1102 includes a system on a chip (SOC). In some embodiments, the processing circuitry 1102 includes one or more of radio frequency (RF) transceiver circuitry 1112 and baseband processing circuitry 1114. In some embodiments, the radio frequency (RF) transceiver circuitry 1112 and the baseband processing circuitry 1114 may be on separate chips (or sets of chips), boards, or units, such as radio units and digital units. In alternative embodiments, part or all of RF transceiver circuitry 1112 and baseband processing circuitry 1114 may be on the same chip or set of chips, boards, or units.

The memory 1104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1102. The memory 1104 may store any suitable instructions, data, or information, including a computer program, software, an application including one or more of logic, rules, code, tables, and/or other instructions capable of being executed by the processing circuitry 1102 and utilized by the network node 1100. The memory 1104 may be used to store any calculations made by the processing circuitry 1102 and/or any data received via the communication interface 1106. In some embodiments, the processing circuitry 1102 and memory 1104 is integrated.

The communication interface 1106 is used in wired or wireless communication of signaling and/or data between a network node, access network, and/or UE. As illustrated, the communication interface 1106 comprises port(s)/terminal(s) 1116 to send and receive data, for example to and from a network over a wired connection. The communication interface 1106 also includes radio front-end circuitry 1118 that may be coupled to, or in certain embodiments a part of, the antenna 1110. Radio front-end circuitry 1118 comprises filters 1120 and amplifiers 1122. The radio front-end circuitry 1118 may be connected to an antenna 1110 and processing circuitry 1102. The radio front-end circuitry may be configured to condition signals communicated between antenna 1110 and processing circuitry 1102. The radio front-end circuitry 1118 may receive digital data that is to be sent out to other network nodes or UEs via a wireless connection. The radio front-end circuitry 1118 may convert the digital data into a radio signal having the appropriate channel and bandwidth parameters using a combination of filters 1120 and/or amplifiers 1122. The radio signal may then be transmitted via the antenna 1110. Similarly, when receiving data, the antenna 1110 may collect radio signals which are then converted into digital data by the radio front-end circuitry 1118. The digital data may be passed to the processing circuitry 1102. In other embodiments, the communication interface may comprise different components and/or different combinations of components.

In certain alternative embodiments, the network node 1100 does not include separate radio front-end circuitry 1118, instead, the processing circuitry 1102 includes radio front-end circuitry and is connected to the antenna 1110. Similarly, in some embodiments, all or some of the RF transceiver circuitry 1112 is part of the communication interface 1106. In still other embodiments, the communication interface 1106 includes one or more ports or terminals 1116, the radio front-end circuitry 1118, and the RF transceiver circuitry 1112, as part of a radio unit (not shown), and the communication interface 1106 communicates with the baseband processing circuitry 1114, which is part of a digital unit (not shown).

The antenna 1110 may include one or more antennas, or antenna arrays, configured to send and/or receive wireless signals. The antenna 1110 may be coupled to the radio front-end circuitry 1118 and may be any type of antenna capable of transmitting and receiving data and/or signals wirelessly. In certain embodiments, the antenna 1110 is separate from the network node 1100 and connectable to the network node 1100 through an interface or port.

The antenna 1110, communication interface 1106, and/or the processing circuitry 1102 may be configured to perform any receiving operations and/or certain obtaining operations described herein as being performed by the network node. Any information, data and/or signals may be received from a UE, another network node and/or any other network equipment. Similarly, the antenna 1110, the communication interface 1106, and/or the processing circuitry 1102 may be configured to perform any transmitting operations described herein as being performed by the network node. Any information, data and/or signals may be transmitted to a UE, another network node and/or any other network equipment.

The power source 1108 provides power to the various components of network node 1100 in a form suitable for the respective components (e.g., at a voltage and current level needed for each respective component). The power source 1108 may further comprise, or be coupled to, power management circuitry to supply the components of the network node 1100 with power for performing the functionality described herein. For example, the network node 1100 may be connectable to an external power source (e.g., the power grid, an electricity outlet) via an input circuitry or interface such as an electrical cable, whereby the external power source supplies power to power circuitry of the power source 1108. As a further example, the power source 1108 may comprise a source of power in the form of a battery or battery pack which is connected to, or integrated in, power circuitry. The battery may provide backup power should the external power source fail.

Embodiments of the network node 1100 may include additional components beyond those shown in FIG. 11 for providing certain aspects of the network node's functionality, including any of the functionality described herein and/or any functionality necessary to support the subject matter described herein. For example, the network node 1100 may include user interface equipment to allow input of information into the network node 1100 and to allow output of information from the network node 1100. This may allow a user to perform diagnostic, maintenance, repair, and other administrative functions for the network node 1100.

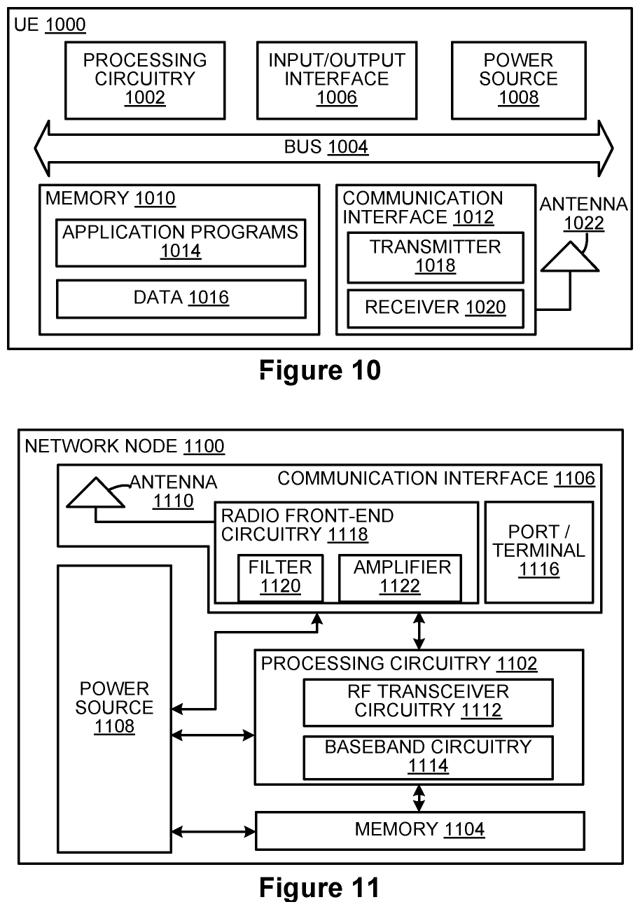

FIG. 12 is a block diagram of a host 1200, which may be an embodiment of the host 816 of FIG. 8, in accordance with various aspects described herein. As used herein, the host 1200 may be or comprise various combinations hardware and/or software, including a standalone server, a blade server, a cloud-implemented server, a distributed server, a virtual machine, container, or processing resources in a server farm. The host 1200 may provide one or more services to one or more UEs.

The host 1200 includes processing circuitry 1202 that is operatively coupled via a bus 1204 to an input/output interface 1206, a network interface 1208, a power source 1210, and a memory 1212. Other components may be included in other embodiments. Features of these components may be substantially similar to those described with respect to the devices of previous figures, such as FIGS. 10 and 11, such that the descriptions thereof are generally applicable to the corresponding components of host 1200.

The memory 1212 may include one or more computer programs including one or more host application programs 1214 and data 1216, which may include user data, e.g., data generated by a UE for the host 1200 or data generated by the host 1200 for a UE. Embodiments of the host 1200 may utilize only a subset or all of the components shown. The host application programs 1214 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1214 may also provide for user authentication and licensing checks and may periodically report health, routes, and content availability to a central node, such as a device in or on the edge of a core network. Accordingly, the host 1200 may select and/or indicate a different host for over-the-top services for a UE. The host application programs 1214 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

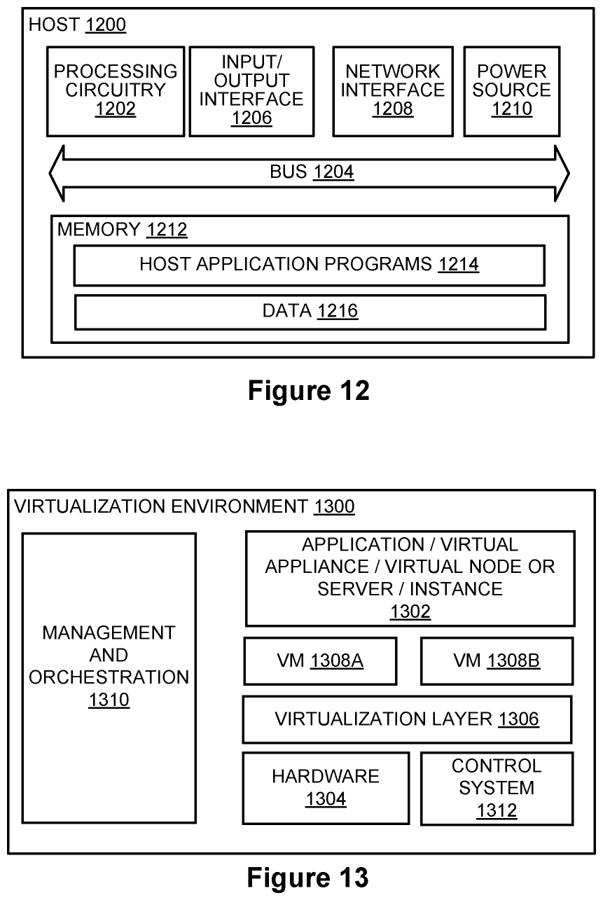

FIG. 13 is a block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1302 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1304 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1306 (also referred to as hypervisors or virtual machine monitors (VMMs)), provide VMs 1308A and 1308B (one or more of which may be generally referred to as VMs 1308), and/or perform any of the functions, features and/or benefits described in relation with some embodiments described herein. The virtualization layer 1306 may present a virtual operating platform that appears like networking hardware to the VMs 1308.

The VMs 1308 comprise virtual processing, virtual memory, virtual networking or interface and virtual storage, and may be run by a corresponding virtualization layer 1306. Different embodiments of the instance of a virtual appliance 1302 may be implemented on one or more of VMs 1308, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1308 may be a software implementation of a physical machine that runs programs as if they were executing on a physical, non-virtualized machine. Each of the VMs 1308, and that part of hardware 1304 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1308 on top of the hardware 1304 and corresponds to the application 1302.

Hardware 1304 may be implemented in a standalone network node with generic or specific components. Hardware 1304 may implement some functions via virtualization. Alternatively, hardware 1304 may be part of a larger cluster of hardware (e.g., such as in a data center or CPE) where many hardware nodes work together and are managed via management and orchestration 1310, which, among others, oversees lifecycle management of applications 1302. In some embodiments, hardware 1304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1312 which may alternatively be used for communication between hardware nodes and radio units.

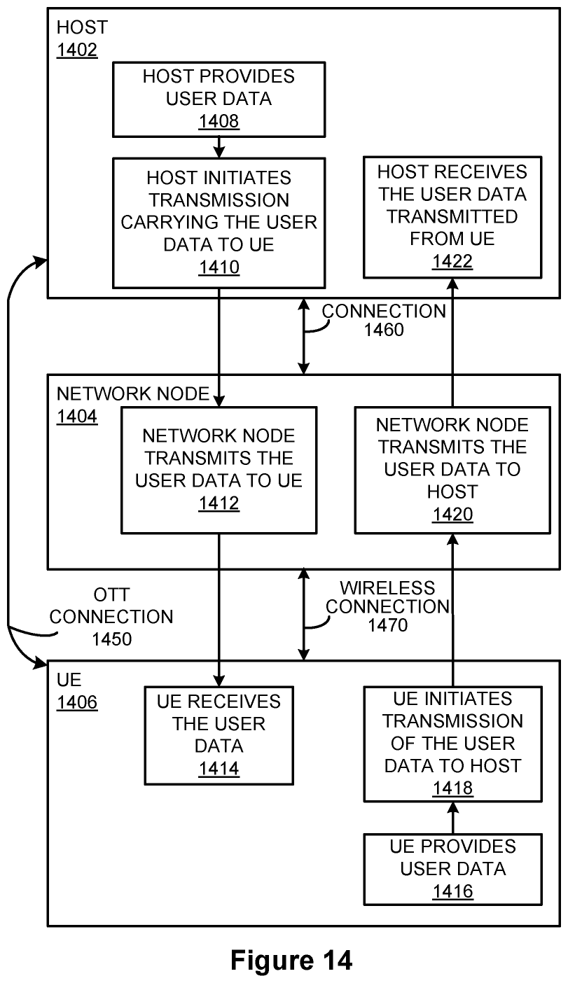

FIG. 14 shows a communication diagram of a host 1402 communicating via a network node 1404 with a UE 1406 over a partially wireless connection in accordance with some embodiments. Example implementations, in accordance with various embodiments, of the UE (such as a UE 812a of FIG. 8 and/or UE 1000 of FIG. 10), network node (such as network node 810a of FIG. 8 and/or network node 1100 of FIG. 11), and host (such as host 816 of FIG. 8 and/or host 1200 of FIG. 12) discussed in the preceding paragraphs will now be described with reference to FIG. 14.

Like host 1200, embodiments of host 1402 include hardware, such as a communication interface, processing circuitry, and memory. The host 1402 also includes software, which is stored in or accessible by the host 1402 and executable by the processing circuitry. The software includes a host application that may be operable to provide a service to a remote user, such as the UE 1406 connecting via an over-the-top (OTT) connection 1450 extending between the UE 1406 and host 1402. In providing the service to the remote user, a host application may provide user data which is transmitted using the OTT connection 1450.

The network node 1404 includes hardware enabling it to communicate with the host 1402 and UE 1406. The connection 1460 may be direct or pass through a core network (like core network 806 of FIG. 8) and/or one or more other intermediate networks, such as one or more public, private, or hosted networks. For example, an intermediate network may be a backbone network or the Internet.

The UE 1406 includes hardware and software, which is stored in or accessible by UE 1406 and executable by the UE's processing circuitry. The software includes a client application, such as a web browser or operator-specific “app” that may be operable to provide a service to a human or non-human user via UE 1406 with the support of the host 1402. In the host 1402, an executing host application may communicate with the executing client application via the OTT connection 1450 terminating at the UE 1406 and host 1402. In providing the service to the user, the UE's client application may receive request data from the host's host application and provide user data in response to the request data. The OTT connection 1450 may transfer both the request data and the user data. The UE's client application may interact with the user to generate the user data that it provides to the host application through the OTT connection 1450.

The OTT connection 1450 may extend via a connection 1460 between the host 1402 and the network node 1404 and via a wireless connection 1470 between the network node 1404 and the UE 1406 to provide the connection between the host 1402 and the UE 1406. The connection 1460 and wireless connection 1470, over which the OTT connection 1450 may be provided, have been drawn abstractly to illustrate the communication between the host 1402 and the UE 1406 via the network node 1404, without explicit reference to any intermediary devices and the precise routing of messages via these devices.

As an example of transmitting data via the OTT connection 1450, in step 1408, the host 1402 provides user data, which may be performed by executing a host application. In some embodiments, the user data is associated with a particular human user interacting with the UE 1406. In other embodiments, the user data is associated with a UE 1406 that shares data with the host 1402 without explicit human interaction. In step 1410, the host 1402 initiates a transmission carrying the user data towards the UE 1406. The host 1402 may initiate the transmission responsive to a request transmitted by the UE 1406. The request may be caused by human interaction with the UE 1406 or by operation of the client application executing on the UE 1406. The transmission may pass via the network node 1404, in accordance with the teachings of the embodiments described throughout this disclosure. Accordingly, in step 1412, the network node 1404 transmits to the UE 1406 the user data that was carried in the transmission that the host 1402 initiated, in accordance with the teachings of the embodiments described throughout this disclosure. In step 1414, the UE 1406 receives the user data carried in the transmission, which may be performed by a client application executed on the UE 1406 associated with the host application executed by the host 1402.

In some examples, the UE 1406 executes a client application which provides user data to the host 1402. The user data may be provided in reaction or response to the data received from the host 1402. Accordingly, in step 1416, the UE 1406 may provide user data, which may be performed by executing the client application. In providing the user data, the client application may further consider user input received from the user via an input/output interface of the UE 1406. Regardless of the specific manner in which the user data was provided, the UE 1406 initiates, in step 1418, transmission of the user data towards the host 1402 via the network node 1404. In step 1420, in accordance with the teachings of the embodiments described throughout this disclosure, the network node 1404 receives user data from the UE 1406 and initiates transmission of the received user data towards the host 1402. In step 1422, the host 1402 receives the user data carried in the transmission initiated by the UE 1406.

In an example scenario, factory status information may be collected and analyzed by the host 1402. As another example, the host 1402 may process audio and video data which may have been retrieved from a UE for use in creating maps. As another example, the host 1402 may collect and analyze real-time data to assist in controlling vehicle congestion (e.g., controlling traffic lights). As another example, the host 1402 may store surveillance video uploaded by a UE. As another example, the host 1402 may store or control access to media content such as video, audio, VR or AR which it can broadcast, multicast or unicast to UEs. As other examples, the host 1402 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1450 between the host 1402 and UE 1406, in response to variations in the measurement results. The measurement procedure and/or the network functionality for reconfiguring the OTT connection may be implemented in software and hardware of the host 1402 and/or UE 1406. In some embodiments, sensors (not shown) may be deployed in or in association with other devices through which the OTT connection 1450 passes; the sensors may participate in the measurement procedure by supplying values of the monitored quantities exemplified above or supplying values of other physical quantities from which software may compute or estimate the monitored quantities. The reconfiguring of the OTT connection 1450 may include message format, retransmission settings, preferred routing etc.; the reconfiguring need not directly alter the operation of the network node 1404. Such procedures and functionalities may be known and practiced in the art. In certain embodiments, measurements may involve proprietary UE signaling that facilitates measurements of throughput, propagation times, latency and the like, by the host 1402. The measurements may be implemented in that software causes messages to be transmitted, in particular empty or ‘dummy’ messages, using the OTT connection 1450 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EMBODIMENTS

1. A method performed by a radio access network, RAN, node (910A, 910B, 1100, 1302, 1308A, 1308B) to configure a wireless device (912A, 912B, 912C, 912D, 1000, 1302, 1308A, 1308B) to perform and report uplink packet data convergence protocol, PDCP, excess delay measurements, the method comprising:
configuring (303) the wireless device (912A, 912B, 912C, 912D, 1000, 1302, 1308A, 1308B) with an excess delay configuration to perform uplink PDCP excess delay measurements;
receiving (305) an excess delay measurement report from the wireless device (912A, 912B, 912C, 912D, 1000, 1302, 1308A, 1308B) based on the excess delay configuration, the excess delay measurement report including a list of PDCP excess delay measurements; and
performing (307) at least one action based on the excess delay measurement report.

2. The method of Embodiment 1, wherein the excess delay configuration comprises one or more of:
a list of data radio bearer, DRB, identities, IDS, for which the wireless device is to perform the PDCP excess delay measurements;
a list of thresholds associated with the DRB IDs for which the wireless device is to perform the PDCP excess delay measurements; and/or
a map between the DRB IDs and the list of thresholds;

3. The method of Embodiment 1, further comprising:
receiving (301) the excess delay configuration including a list of PDCP excess delay thresholds associated with the DRB IDs and/or with single-network slice selection assistance information, S-NSSAI, from another network entity.

4. The method of Embodiment 3, wherein the other network entity comprises one of a core network element, another radio access network node, or from an operations, administration, and maintenance, OAM, node.

5. The method of any of Embodiments 1-4, wherein configuring the wireless device with the excess delay configuration comprises configuring the wireless device with the excess delay configuration via one of a radio resource management, RRM, configuration or a minimization of drive test, MDT, configuration.

6. The method of any of Embodiments 1-5, wherein receiving the excess delay measurement report comprises receiving the excess delay measurement report as part of a minimization of drive test, MDT, report.

7. The method of any of Embodiments 1-5, wherein receiving the excess delay measurement report comprises receiving the excess delay measurement report as part of a radio resource management, RRM, measurement report.

8. The method of any of Embodiments 1-7, further comprising:
responsive to the excess delay measurement report containing multiple excess delay results per data radio bearer, DRB/single-network slice selection assistance information, S-NSSAI (401), producing (403) an excess delay probability distribution function, PDF, or cumulative distribution function, CDF, for analysis and using the excess delay PDF or CDF for scheduling.

9. The method of any of Embodiments 1-8, wherein performing the at least one action comprises forwarding (501) the excess delay measurement report including the list of PDCP excess delay measurements associated with data radio bearer, DRB, identifications, IDs, towards other network entities.

10. The method of Embodiment 9, wherein the other network entities comprise at least one of a core network element such as an access and mobility management function, AMF, or a user plane function, UPF, another RAN node, a distributed unit in a split RAN architecture, and/or an operations, administration, and management system.

11. The method of any of Embodiments 9-10, wherein forwarding the excess delay measurement report comprises combining the excess delay measurement report with other reports to produce a combined measurement report and transmitting the combined measurement report towards the other entities.

12. The method of Embodiment 11, wherein combining the excess delay measurement report with other reports comprises combining the excess delay measurement report with one or more of an over-the-air excess delay report, an internal excess delay report and an interface excess delay report.

13. The method of any of Embodiments 1-8, wherein performing the at least one action comprises signaling (503) a radio access network, RAN, node hosting PDCP with one or more of:
the excess delay measurement report;
an indication that an excess delay ratio exceeds a threshold; and
an indication that the excess delay ratio is above or below acceptable limits.

14. The method of any of Embodiments 1-8, wherein performing the at least one action comprises triggering (505) an indication towards a core network to indicate that the quality of service, QoS, for the PDU Sessions whose traffic is affected by poor excess delay ratio does not meet the requested QoS levels previously required by the core network or the RAN for the UE in question.

15. The method of any of Embodiments 1-14, further comprising:
responsive to the excess delay measurement report indicating excess delay is above a threshold value (601), performing (603) one or more of: increasing a scheduling priority; increasing a transmission rate in the UL for affected DRBs; throttling UL traffic for affected QoS DRBs; and/or reallocating radio resources to minimize measured excess delay per each DRB.

16. The method of Embodiment 14, wherein reallocating the radio resources comprises reallocating the radio resources among DRBs to minimize measured excess delay and expected delay per each DRB.

17. The method of any of Embodiments 1-16, further comprising:
transmitting an indication to the wireless device to initiate an excess delay measurement.

18. The method of any of Embodiments 1-16, further comprising:
transmitting an indication to the wireless device to stop an excess delay measurement.

19. The method of any of Embodiments 1-16, further comprising:
when the RAN node is operating in a split RAN architecture, transmitting an indication by the distributed unit in the split RAN architecture to the centralized unit in the split RAN architecture an indication to initiate the excess delay measurement or an indication to stop the excess delay measurement.

20. A method performed by a wireless device (912A, 912B, 912C, 912D, 1000, 1302, 1308A, 1308B) to receive an excess delay measurement configuration from a serving radio access network, RAN, node and perform measurements according to the excess delay configuration, the method comprising:
receiving (701) an excess delay configuration to perform uplink PDCP excess delay measurements;
performing (705) uplink PDCP excess delay measurements based on threshold values in the excess delay configuration; and
transmitting (707) an excess delay measurement report to the serving RAN node, the excess delay measurement report including a list of PDCP excess delay measurements.

21. The method of Embodiment 20, further comprising:
receiving (703) a trigger to perform uplink PDCP excess delay measurements.

22. The method of Embodiment 20, further comprising:
receiving a trigger to stop uplink PDCP excess delay measurements.

23. The method of Embodiment 20, wherein receiving the excess delay configuration comprises receiving (801) a list of data radio bearer, DRB, identities, IDs, for which the wireless device is to perform uplink PDCP excess delay measurements.

24. The method of Embodiment 20, wherein receiving the excess delay configuration comprises receiving (803) a list of thresholds to which the wireless device is to calculate the uplink PDCP excess delay measurements.

25. The method of Embodiment 20, wherein the list of thresholds is associated with a list of data radio bearer, DRB, identities, IDs.

26. The method of Embodiment 20, wherein receiving the excess delay configuration comprises receiving (805) a mapping between a list of data resource bearer, DRB, identities, IDs, and a list of thresholds to which the wireless device is to calculate the uplink PDCP excess delay measurements.

27. The method of Embodiment 26, wherein the mapping consists of a one-to-one relation between elements in the list of DRB IDs and the list of thresholds.

28. The method of Embodiment 20, wherein receiving the excess delay configuration comprises receiving (807) a list of single-network slice selection assistance information, S-NSSAI. Identities entity for which the wireless device is to perform uplink PDCP excess delay measurements.

29. The method of Embodiment 20, wherein receiving the excess delay configuration comprises receiving (809) a list of thresholds, each associated to a single-network slice selection assistance information, S-NSSAI, to which the UE is to use to calculate the UL PDCP excess delay measurements.

30. The method of any of Embodiments 28-29, wherein the excess delay configuration comprises a one-to-many relation between elements of a list of data resource bearer DRBs identifications, IDs, or S-NSSAIs or the list of thresholds of the list of DRB IDs and S-NSSAIs and the list of thresholds.

31. The method of any of Embodiments 20-30 wherein receiving the excess delay configuration comprises receiving the excess delay configuration as part of a minimization of drive test configuration.

32. The method of any of Embodiments 20-31, further comprising:
responsive to the excess delay configuration having multiple threshold values related to a single DRB or S-NSSAI, including all excess delay measurements in a list associating with the single DRB/NSSAI.

33. The method of Embodiment 32, wherein an order of elements in the list refers to an order of the threshold values configured by the network.

34. The method of Embodiment 33, further comprising including the threshold values and excess delay values in the list.

35. A radio access network, RAN, node (910A, 910B, 1100, 1302, 1308A, 1308B) for configuring a wireless device to perform and report uplink packet data convergence protocol, PDCP, excess delay measurements, the network node adapted to:
configure (303) the wireless device with an excess delay configuration to perform uplink PDCP excess delay measurements;
receive (305) an excess delay measurement report from the wireless device based on the excess delay configuration, the excess delay measurement report including a list of PDCP excess delay measurements; and
perform (307) at least one action based on the excess delay measurement report.

36. The network node of Embodiment 35, wherein the network node is further adapted to perform in accordance with Embodiments 2-19.

37. A radio access network, RAN, node (910A, 910B, 1100, 1302, 1308A, 1308B) for configuring a wireless device to perform and report uplink packet data convergence protocol, PDCP, excess delay measurements, the network node comprising:
processing circuitry (1102); and
memory (1104) coupled with the processing circuitry, wherein the memory includes instructions that when executed by the processing circuitry causes the network node to perform operations comprising:
   configuring (303) the wireless device with an excess delay configuration to perform uplink PDCP excess delay measurements;
   receiving (305) an excess delay measurement report from the wireless device based on the excess delay configuration, the excess delay measurement report including a list of PDCP excess delay measurements; and
   performing (307) at least one action based on the excess delay measurement report.

38. The network node of Embodiment 37, wherein the memory includes further instructions that when executed by the processing circuitry causes the network node to perform operations according to Embodiments 2-19.

30. A wireless device (912A, 912B, 912C, 912D, 1000, 1302, 1308A, 1308B) configured for receiving an excess delay measurement configuration from a serving radio access network, RAN, node (910A, 910B, 1100, 1302, 1308A, 1308B) and performing measurements according to the excess delay configuration, the wireless device adapted to:
receive (701) an excess delay configuration to perform uplink PDCP excess delay measurements;
perform (705) uplink PDCP excess delay measurements based on threshold values in the excess delay configuration; and
transmit (707) an excess delay measurement report to the serving RAN node, the excess delay measurement report including a list of PDCP excess delay measurements.

40. The wireless device of Embodiment 40, wherein the wireless device is further adapted to perform in accordance with Embodiments 21-34.

41. A wireless device (912A, 912B, 912C, 912D, 1000, 1302, 1308A, 1308B) for receiving an excess delay configuration and performing uplink packet data convergence protocol, PDCP, excess delay measurements, the wireless device comprising:
processing circuitry (1002); and
memory (1010) coupled with the processing circuitry, wherein the memory includes instructions that when executed by the processing circuitry causes the wireless device to perform operations comprising:
   receiving (701) an excess delay configuration to perform uplink PDCP excess delay measurements;
   performing (705) uplink PDCP excess delay measurements based on threshold values in the excess delay configuration; and
   transmitting (707) an excess delay measurement report to a serving radio access network, RAN, node, the excess delay measurement report including a list of PDCP excess delay measurements.

42. The wireless device of Embodiment 41, wherein the memory includes further instructions that when executed by the processing circuitry causes the wireless device to perform operations according to Embodiments 21-34.

43. A computer program comprising program code to be executed by processing circuitry of a radio access network, RAN, node (910A, 910B, 1100, 1302, 1308A, 1308B), whereby execution of the program code causes the RAN node to perform operations comprising:
configuring (303) a wireless device with an excess delay configuration to perform uplink packet data convergence protocol, PDCP, excess delay measurements;
receiving (305) an excess delay measurement report from the wireless device based on the excess delay configuration, the excess delay measurement report including a list of PDCP excess delay measurements; and
performing (307) at least one action based on the excess delay measurement report.

44. The computer program of Embodiment 43 comprising further program code to be executed by processing circuitry, whereby execution of the program code causes the RAN node to perform operations according to any of Embodiments 2-19.

45. A computer program product comprising a non-transitory storage medium including program code to be executed by processing circuitry of a radio access network, RAN, node (910A, 910B, 1100, 1302, 1308A, 1308B), whereby execution of the program code causes the RAN node to perform operations comprising:
configuring (303) a wireless device with an excess delay configuration to perform uplink packet data convergence protocol, PDCP, excess delay measurements;
receiving (305) an excess delay measurement report from the wireless device based on the excess delay configuration, the excess delay measurement report including a list of PDCP excess delay measurements; and
performing (307) at least one action based on the excess delay measurement report.

46. The computer program product of Embodiment 45 wherein the non-transitory storage medium includes further program code to be executed by processing circuitry of the RAN node, whereby execution of the program code causes the network node to perform operations according to any of Embodiments 2-19.

47. A computer program comprising program code to be executed by processing circuitry of a wireless device, whereby execution of the program code causes the wireless device to perform operations comprising:
receiving (701) an excess delay configuration to perform uplink packet data convergence protocol, PDCP, excess delay measurements;
performing (703) uplink PDCP excess delay measurements based on threshold values in the excess delay configuration; and
transmitting (705) an excess delay measurement report to a serving radio access network, RAN, node, the excess delay measurement report including a list of PDCP excess delay measurements.

48. The computer program of Embodiment 47 comprising further program code to be executed by processing circuitry, whereby execution of the program code causes the network node to perform operations according to any of Embodiments 21-34.

49. A computer program product comprising a non-transitory storage medium including program code to be executed by processing circuitry of a network node, whereby execution of the program code causes the network node to perform operations comprising:
receiving (701) an excess delay configuration to perform uplink packet data convergence protocol, PDCP, excess delay measurements;
performing (705) uplink PDCP excess delay measurements based on threshold values in the excess delay configuration; and
transmitting (707) an excess delay measurement report to a serving radio access network, RAN, node, the excess delay measurement report including a list of PDCP excess delay measurements.

50. The computer program product of Embodiment 49 wherein the non-transitory storage medium includes further program code to be executed by processing circuitry of the network node, whereby execution of the program code causes the network node to perform operations according to any of Embodiments 21-34.

References are identified below
1. 3GPP TS 38.401 v16.5.0, NG-RAN; Architecture description
2. 3GPP TS 36.314 v16.0.0, Evolved Universal Terrestrial Radio Access (E-UTRA); Layer 2—Measurements
3. 3GPP TS 36.331v16.7.0, Evolved Universal Terrestrial Radio Access (E-UTRA); Radio Resource Control (RRC); Protocol specification

1. A method performed by a wireless device to receive an excess delay measurement configuration from a serving radio access network, RAN, node and perform measurements according to the excess delay configuration, the method comprising:
receiving an excess delay configuration to perform uplink PDCP excess delay measurements, the excess delay configuration including a list of PDCP excess delay thresholds associated with data radio bearer, DRB, identities, IDs;
performing uplink PDCP excess delay measurements based on threshold values in the excess delay configuration; and
transmitting an excess delay measurement report to the serving RAN node, the excess delay measurement report including a list of PDCP excess delay measurements.

2. The method of claim 1, further comprising:
receiving a trigger to perform uplink PDCP excess delay measurements.

3. The method of claim 1, wherein receiving the excess delay configuration comprises at least one of:
receiving a list of data radio bearer, DRB, identities, IDs, for which the wireless device is to perform uplink PDCP excess delay measurements;
receiving a list of thresholds to which the wireless device is to calculate the uplink PDCP excess delay measurements, wherein the list of thresholds is associated with a list of data radio bearer, DRB, identities, IDs; and
receiving a mapping between a list of data resource bearer, DRB, identities, IDs, and a list of thresholds to which the wireless device is to calculate the uplink PDCP excess delay measurements, wherein the mapping consists of a one-to-one relation between elements in the list of DRB IDs and the list of thresholds.

4. The method of claim 1 wherein receiving the excess delay configuration comprises receiving the excess delay configuration as part of a minimization of drive test configuration.

5. The method of claim 1, further comprising:
responsive to the excess delay configuration having multiple threshold values related to a single DRB, including all excess delay measurements in a list associating with the single DRB.

6. The method of claim 5, wherein an order of elements in the list refers to an order of the threshold values configured by the network.

7. The method of claim 6, further comprising including the threshold values and excess delay values in the list.

8. A method performed by a radio access network, RAN, node to configure a wireless device to perform and report uplink packet data convergence protocol, PDCP, excess delay measurements, the method comprising:
configuring the wireless device with an excess delay configuration to perform uplink PDCP excess delay measurements, the excess delay configuration including a list of PDCP excess delay thresholds associated with data radio bearer, DRB, identities, IDs;
receiving an excess delay measurement report from the wireless device based on the excess delay configuration, the excess delay measurement report including a list of PDCP excess delay measurements; and
performing at least one action based on the excess delay measurement report.

9. The method of claim 8, wherein the excess delay configuration comprises one or more of:
a list of data radio bearer, DRB, identities, IDS, for which the wireless device is to perform the PDCP excess delay measurements;
a list of thresholds associated with the DRB IDs for which the wireless device is to perform the PDCP excess delay measurements; and/or
a map between the DRB IDs and the list of thresholds;

10. The method of claim 8, further comprising:
receiving the excess delay configuration including a list of PDCP excess delay thresholds associated with the DRB IDs and/or with single-network slice selection assistance information, S-NSSAI, from another network entity.

11. The method of claim 10, wherein the other network entity comprises one of a core network element, another radio access network node, or from an operations, administration, and maintenance, OAM, node.

12. The method of claim 8, wherein receiving the excess delay measurement report comprises at least one of:
receiving the excess delay measurement report as part of a minimization of drive test, MDT, report; and
receiving the excess delay measurement report as part of a radio resource management, RRM, measurement report.

13. The method of claim 8, further comprising:
responsive to the excess delay measurement report containing multiple excess delay results per data radio bearer, DRB/single-network slice selection assistance information, S-NSSAI an excess delay probability distribution function, PDF, or cumulative distribution function, CDF, for analysis and using the excess delay PDF or CDF for scheduling.

14. The method of claim 8, wherein performing the at least one action comprises forwarding the excess delay measurement report including the list of PDCP excess delay measurements associated with data radio bearer, DRB, identifications, IDs, towards other network entities.

15. The method of claim 14, wherein the other network entities comprise at least one of a core network element such as an access and mobility management function, AMF, or a user plane function, UPF, another RAN node, a distributed unit in a split RAN architecture, and/or an operations, administration, and management system.

16. The method of claim 8, wherein performing the at least one action comprises signaling a radio access network, RAN, node hosting PDCP with one or more of:
the excess delay measurement report;
an indication that an excess delay ratio exceeds a threshold; and
an indication that the excess delay ratio is above or below acceptable limits.

17. The method of claim 8, wherein performing the at least one action comprises triggering an indication towards a core network to indicate that the quality of service, QoS, for the PDU Sessions whose traffic is affected by poor excess delay ratio does not meet the requested QoS levels previously required by the core network or the RAN for the UE in question.

18. The method of claim 1, further comprising:
responsive to the excess delay measurement report indicating excess delay is above a threshold value, performing one or more of: increasing a scheduling priority; increasing a transmission rate in the UL for affected DRBs; throttling UL traffic for affected QoS DRBs; and/or reallocating radio resources to minimize measured excess delay per each DRB.

19. A wireless device configured for receiving an excess delay measurement configuration from a serving radio access network, RAN, node and performing measurements according to the excess delay configuration, the wireless device adapted to:
receive an excess delay configuration to perform uplink PDCP excess delay measurements, the excess delay configuration including a list of PDCP excess delay thresholds associated with data radio bearer, DRB, identities, IDs;
perform uplink PDCP excess delay measurements based on threshold values in the excess delay configuration; and
transmit an excess delay measurement report to the serving RAN node, the excess delay measurement report including a list of PDCP excess delay measurements.

20. The wireless device of claim 19, wherein the wireless device is further adapted to receive a trigger to perform uplink PDCP excess delay measurements.

21-34. (canceled)
